(19) United States
(12) Patent Application Publication
(10) Pub. No.: US 2006/0279029 A1
(43) Pub. Date: Dec. 14, 2006

(54) Hydroelastic joint comprising a connection circuit for the liquid

(75) Inventor: Philippe Souyri, Saint-Genes-du-Retz (FR)

Correspondence Address: COHEN, PONTANI, LIEBERMAN & PAVANE, 551 FIFTH AVENUE, SUITE 1210, NEW YORK, NY, 10176, US

(73) Assignee: Michelin Recherche et Technique S.A., Granges-Paccot (CH)

(21) Appl. No.: 11/446,939

(22) Filed: Jun. 5, 2006

(30) Foreign Application Priority Data
Jun. 14, 2005 (FR) 05/51611

(51) Int. Cl. F16F 13/00; B60M 5/00; B62D 7/22; F16C 3/00

(52) U.S. Cl. 267/140.12; 403/20; 464/180; 280/90; 74/548

(57) ABSTRACT

Hydroelastic joint comprising an elastically deformable element (6) shaped so as to define, between two armatures (1, 2), a volume containing a damping liquid and comprising at least two chambers (10, 11) opposite one another along a predefined damping direction. The joint comprises a connection circuit that connects the chambers, and flow control means (26, 27) that can be switched to a first asymmetrical state in which the flow resistance of the connection circuit is lower in a first direction from a first of the chambers to a second of the chambers than in a second direction from the second chamber to the first chamber, and a second asymmetrical condition in which the flow resistance of the connection circuit is lower in the second direction than in the first direction.

### FIELD OF THE INVENTION

The present invention relates to the field of hydroelastic joints of the type designed to connect two components while damping the vibrations transmitted between one and the other. Such a joint comprises an outer armature and an inner armature arranged one around the other, and an elastically deformable element arranged between the armatures so as to allow relative displacement between them, the elastically deformable element being shaped so as to define, between the armatures, a volume containing a damping liquid and comprising at least two chambers which are opposed along a predefined damping direction.

Joints of this type have two main functions: to allow degrees of freedom between the components they hold together, and to attenuate the transmission of vibrations between one and the other of those components.

### BACKGROUND OF THE INVENTION

In the field of automobile vehicle design such joints were first used to damp the power train relative to the main structure or body of a vehicle, and then also to damp the ground contact elements such as the suspension wishbones of wheel trains relative to the main structure.

As regards the latter, the damping particularly envisaged is that of displacement modes in the longitudinal direction of the vehicle, such as the recoil movement of a wheel on contact with an obstacle. Sources of vibrations known at the level of the ground contact elements are also, for example, the non-uniformity of tires when rolling, brake disc defects and braking assistance devices. The vibrations of the ground contact elements generally have relatively low resonance frequencies, for example between 15 and 20 Hz, and relatively large amplitudes, so that they are perceptible by the vehicle's occupants unless adequately damped. Vibrations of higher frequency are also present and influence the comfort of the vehicle at the acoustic level.

Schematically, when a vibratory excitation is exerted on one of the armatures, at least in the damping direction, this brings about an elastic deformation of the deformable element, which is made for example of an elastomer, a variation of the volume of the chambers, a pressure difference between them, and finally a flow of damping liquid through a connection circuit between the chambers. In particular the connection circuit can be made in the form of a resonant channel of limited cross-section. Thus, by virtue of the liquid's inertia and to an extent amplified by the limited cross-section of the resonant channel, which results in an increase in the liquid's speed, this flow is out of phase with the force that produces it, with the consequence that the effect transmitted to the second armature is damped. The damping characteristics of this type of joint are measured as a dynamic rigidity, which is the ratio between the excitation transmitted to the second armature and the vibratory displacement imposed on the first. Such a dynamic rigidity varies with the frequency and amplitude of the excitatory displacement. Using a classical notation with complex numbers for the harmonic magnitudes of input displacement and output effect, the dynamic rigidity is expressed in the form of a complex number characterised by an amplitude termed the rigidity and a phase termed the phase shift.

In a known way, the dynamic rigidity can be adapted by appropriate choice of the composition and geometry of the deformable element, the viscosity of the damping liquid, which is for example a water-glycol mixture, and the cross-section and length of the resonant channel, so as to adjust the resonance frequency of the joint. This resonance frequency corresponds to the frequency at which the damping performance of the joint is optimum, i.e. when the phase shift is maximum.

U.S. Pat. No. 4,687,223 discloses a hydroelastic joint for the ground contact member of a vehicle, in which the two liquid chambers are spaced apart in the longitudinal direction of the vehicle and are connected by a passage provided with an electric solenoid valve. The electric valve is kept open by a spring when the solenoid is not energized, so as to allow the liquid to flow back and forth between the chambers, and is closed when the solenoid is energized, so as to prevent any flow of liquid between the chambers and thus to increase the rigidity of the joint in the longitudinal direction of the vehicle. This system serves to improve the stability of the vehicle when driving round a bend.

DE 19739803 describes a hydroelastic joint for the attachment of an engine to the body of a vehicle. A damping valve is arranged in a main liquid chamber. This chamber is located on the side of the joint facing the body of the vehicle, so as to receive the vibratory shocks in the first place before the auxiliary chamber on the side of the joint facing the power train. A control unit energises the valve's electromagnet when a shock sensor detects a shock, so as to enable small quantities of liquid to circulate between the main chamber and the auxiliary chamber through narrow channels in a damping plate. Once the shock has been damped, the electromagnet is de-energised and the damping valve assumes a neutral condition. The damping valve only closes if the pressure on the side of the auxiliary chamber becomes higher than the pressure on the side of the main chamber.

### SUMMARY OF THE INVENTION

One object of the present invention is to provide a hydroelastic joint, in particular for the connection of a vehicle's ground contact elements, whose damping characteristics can adapt to various vehicle operation situations.

Another object of the invention is to obtain this result with a device whose bulk and/or cost are advantageous.

These and other objects are attained with one aspect of the present invention directed to a hydroelastic joint designed to connect two components while damping vibrations transmitted from one to the other. The joint comprises an outer armature and an inner armature arranged one around the other with an elastically deformable element arranged between the armatures so as to allow relative displacement between them. The elastically deformable element is shaped so as to define, between the armatures, a volume containing a damping liquid and comprising at least two chambers opposed along a predefined damping direction. The joint comprises a circuit that connects the chambers and flow control means that can be switched to several states in order to modify the flow resistance of the connection circuit between the two chambers. The flow control means have a first, asymmetrical state in which the flow resistance of the connecting circuit is lower in a first direction from a first of the chambers to a second of the chambers than it is in a second direction from the second chamber to the first chamber, and a second asymmetrical state in which the flow resistance of the connection circuit is lower in the second direction than in the first direction.

By providing the possibility of treating the liquid flows differently depending on their circulation direction between the chambers, such a joint enables an adjustable rigidity to be obtained, which can be set to a lower or higher value in relation to forces or displacements applied in a particular direction than in the other directions, according to the needs imposed by the application envisaged.

Advantageously, the first asymmetrical state and the second asymmetrical state are two one-way states of passage in which the flow control means prevent a flow of damping liquid in the second direction and in the first direction, respectively. Thus, the joint can temporarily retain a displacement in one direction that has been selected inasmuch as desired.

Preferably, the flow control means comprise two controlled valves arranged in the connection circuit between the first and second chambers, each of the valves having a two-way pass state and a one-way pass state, a first of the valves having its one-way pass state oriented in the first direction and a second of the valves having its one-way pass state oriented in the second direction. Thus, the flow control means can provide more than two operating conditions of the joint, for example four operating conditions by independent switching of the two valves. Furthermore, this type of valve can be made using components of small bulk, so for example enabling the connection circuit and the flow control means to be accommodated in a joint of ordinary size.

Advantageously, the two valves are arranged in series between the first chamber and the second chamber. Thus, depending on the state of each of the two valves, a connection circuit is obtained which can be switched to four distinct conditions: a two-way pass condition (with both valves in their two-way pass states), a one-way pass condition in each direction (with one of the two valves in its one-way pass state), and a blocking condition (with both valves in their one-way pass state). Such a design has the advantage of sharing the function of blocking the circuit between the two controlled valves. Each valve in its one-way pass state has a blocked direction, i.e. the direction opposite to the pass direction. Thus, the first valve in its one-way pass state blocks the circuit in relation to flows of liquid and pressure waves moving in the second direction, while the second valve in its one-way pass state blocks the circuit in relation to flows of liquid and pressure waves moving in the first direction. As a variant, the two valves can be arranged in parallel between the first and second chambers.

Preferably, the first valve is arranged on the side near the second chamber and the second valve is arranged on the side near the first chamber. Due to this arrangement, when a valve is moved to its one-way pass state to block liquid and pressure wave flows moving in the blocking direction of the valve, the waves and flows are stopped close to the chamber from where they come. In other words, the flows and pressure waves to be blocked do not have a sizeable volume in which to propagate upstream from the valve which blocks them, i.e. between the chamber and the valve, and this contributes toward making the joint more rigid in the condition. Moreover, this arrangement facilitates the positioning of the valve actuators. The converse arrangement is also possible.

Preferably, the connection circuit comprises flow guide means for guiding a flow of damping liquid between the chambers, each of the two controlled valves comprising a vane arranged inside the flow guide means which can be moved to a blocking position that corresponds to the one-way pass state of the valve, in which the vane separates two portions of the flow guide means, and at least one open position corresponding to the two-way pass state of the valve, in which the vane re-establishes flow continuity between the two portions of the flow guide means, a restoring element moving the vane to the blocking position and an actuator being able to move the vane to the at least one open position, the vane in the blocking position being arranged such that the pressure of the damping liquid in one of the portions of the flow guide means pushes the vane towards its open position against the action of the restoring element, while the pressure of the damping liquid in the other portion of the flow guide means pushes the vane towards its blocking position. This design of the valves is advantageous because the waves and liquid flows moving in the blocking direction of the valve tend to push the latter into its blocking position, for example against a vane seat arranged in the flow guide means. The movement of the vane to its blocking position does not therefore require a high closing force and can be accomplished by a weak spring that exerts a relatively small restoring force. As a result, the actuator which moves the vane toward its pass position against the action of the restoring element does not need to be very high-powered, so the valve can be operated by a low-powered actuator, which takes up little space.

Advantageously, the vane is guided in a direction that corresponds essentially to the flow direction of the damping liquid in the flow guide means.

According to a particular embodiment, the flow guide means comprise a casing arranged on the outside of the outer armature of the joint, the casing having walls that delimit an inside volume, the walls being pierced by two openings arranged so as to allow communication between the inside volume and each of the two chambers, the vane being able to rest and form a seal against the inside face of one wall of the casing around one of the openings. Advantageously, the actuator is connected to the casing. Such an external casing has the advantage of being able to form a short channel of large cross-section between the two chambers, which improves the filtering of the high frequencies whose influence is decisive for the comfort of the ground contact member, for example in the range between 100 and 300 Hz.

Various types of restoring element can be used, for example a metallic spring, a pneumatic spring or a rubber or magnetic one. Advantageously, the restoring element is a spiral spring resting between the vane and a wall of the casing. A separate casing can be provided for each of the two valves.

Advantageously, the vanes of the two valves are arranged in two inside volumes of a common casing having an internal partition wall that separates the two inside volumes, the internal partition being pierced by an opening that connects the two inside volumes, the two vane seats being formed on the two faces of the internal partition around the connecting opening. This design enables the volume of the valves to be minimized.

Advantageously, the two chambers are defined by recesses formed in the surface of the elastically deformable element facing toward the outer armature.

In another particular embodiment, the joint comprises an intermediate supporting element arranged between the outer armature and the elastically deformable element, the supporting element comprising a first end portion located opposite the first chamber, a second end portion opposite the second chamber and an intermediate portion connecting the first and second end portions, inserted hermetically between the outer armature and the elastically deformable element, the connection circuit comprising a connecting channel formed in the supporting element, the connecting channel having two ends which communicate with the first and second chambers respectively, the first and second valves each comprising an actuator fixed respectively to one of the end portions and a mobile vane that can block the connecting channel in the one-way pass position of the valve.

Preferably, the overall shape of the joint has a circular cross-section and the supporting element has a correspondingly curved shape.

In a particular embodiment the connection circuit and the flow control means are arranged essentially between the outer armature and the elastically deformable element.

In a particular embodiment the connection circuit comprises a first circuit branch having two ends in communication with the two chambers, respectively, and a second circuit branch having two ends in communication with the two chambers, respectively, the second circuit branch matching the contour of the first circuit branch, and the flow control means comprising a valve arranged in each of the two branches.

Preferably, the first circuit branch comprises a first one-way blocking element whose pass direction is the first direction but which blocks in the second direction, and a first controlled valve arranged in series with said first one-way blocking element, the second circuit branch comprising a second one-way blocking element whose pass direction is the second direction but which blocks in the first direction, and a second controlled valve arranged in series with the second one-way blocking element, the first and second controlled valves each having a pass state which allows flow in the corresponding circuit branch and a blocking state which prevents flow in the corresponding circuit branch.

Preferably, the flow control means comprise at least one electric valve, for example with an electromagnetic actuator or a variable reluctance actuator.

Advantageously, the flow control means have a blocking condition which prevents any flow in the connection circuit in either direction between the two chambers. Such a condition gives a high-rigidity operating mode of the joint.

Advantageously, the flow control means have a symmetrical pass condition in which the flow resistance in the connection circuit between the two chambers is substantially equal in both directions. Such a condition makes it possible, for example, to obtain a low-rigidity operating mode of the joint.

Advantageously, at least one overpressure channel of larger effective cross-section than the connection circuit connects the said two chambers and matches the contour of the connection circuit, the overpressure channel comprising an overpressure vane which normally closes the overpressure channel but can open it when the pressure difference between the two chambers exceeds a predetermined threshold.

### BRIEF DESCRIPTION OF THE DRAWINGS

The invention will be better understood and others of its aims, characteristic details and advantages will emerge more clearly from the following description of several particular embodiments of the invention, which are presented only for illustrative purposes but are not limiting, and which refer to the attached drawings showing:

FIG. 1: View of a first embodiment of a joint according to the invention, shown in longitudinal section along the line I-I in FIG. 2.

FIG. 2: View of the joint, shown in transverse section along the line II-II in FIG. 1, associated with a control circuit.

FIG. 3: Hydraulic layout equivalent to the joint of FIG. 2.

FIG. 4: Sectional view of a group of electric valves according to a variant embodiment.

FIG. 5: View analogous to that of FIG. 2, showing a second embodiment of a joint according to the invention.

FIG. 6: Perspective view of a component of the joint in FIG. 5.

FIG. 7: Hydraulic layout of a third embodiment of a joint according to the invention.

FIGS. 8 and 9: Electric valve variant that can be used in the embodiments of FIGS. 3 and 7.

FIG. 10: Diagram representing the force/displacement characteristic of the joint shown in FIG. 2, in several operating conditions.

FIG. 11: Hydraulic layout equivalent to a fourth embodiment of a joint according to the invention.

FIG. 12: Sectional view of a hydraulic circuit with electric valves suitable for the embodiment of FIG. 11.

### DETAILED DESCRIPTION OF THE DRAWINGS

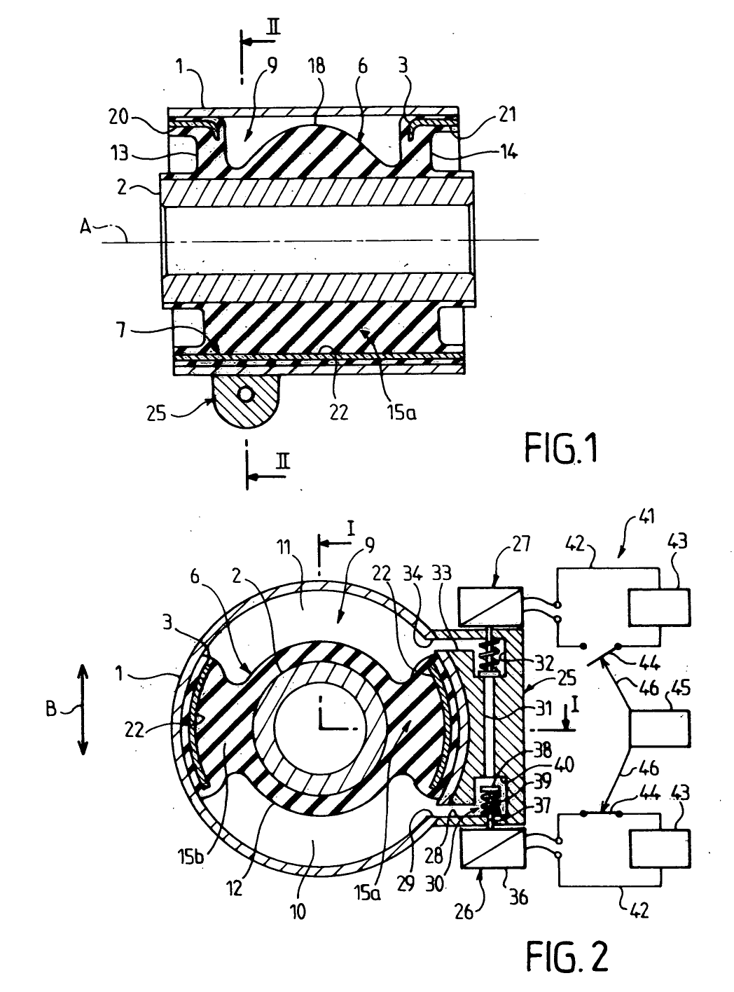

Referring to FIGS. 1 and 2, a first embodiment of the invention is now described. In this embodiment the joint has a cylindrical outer overall shape of circular cross-section, and comprises an outer armature 1 and an inner armature 2 which are essentially cylindrical and coaxial with axis A. These armatures are rigid and are made, for example, of metal or plastic. The outer armature 1 and the inner armature 2 are designed to be fixed respectively to two components of a structure (not shown) to join those components together and damp the transmission of vibrations between them. To facilitate the assembly of the joint between the two components, the inner armature 2 can extend longitudinally beyond the outer armature 1 at the two ends of the joint.

Between the armatures 1 and 2 is fitted an elastically deformable element 6 consisting of one or more elastomer(s) provided with an embedded armature 7. A hydraulic damping liquid fills a volume 9 defined between the deformable element 6 and the inside surface of the outer armature 1. The deformable element 6 has the overall shape of a hollow cylindrical sleeve adhesively bonded at its inside surface to the outer surface of the inner armature 2 and hollowed on its outer surface 12 to form the volume 9.

The outer shape of the deformable element 6 is as follows: the deformable element 6 is hollowed in a central portion between its two axial ends, so as to form at the level of its axial ends two annular walls 13 and 14 that join the inner 2 and outer 1 armatures to enclose hermetically the volume 9, these also being called the cheeks of the joint. Two diametrically opposed axial humps 15a and 15b join the two walls 13 and 14 so as to divide the volume 9 into two essentially semi-annular chambers 10 and 11 which are symmetrical relative to a plane containing the axis A of the joint and the median lines of the humps 15a and 15b. The two chambers 10 and 11 are diametrically opposed in a direction B which defines the hydraulic damping direction of the joint.

It is not essential that the humps 15a and 15b occupy diametrically symmetrical positions and other configurations of the deformable element 6 can be envisaged, depending on the requirements of the application for which the joint is to be used. For example, the symmetrical shape represented is appropriate for an application with no substantial static pre-load. In a case when the joint has to receive a static pre-load of given direction, it is preferable to prevent this pre-load from displacing the axial humps in pure shear, since this would deform those parts irreversibly. It is therefore preferable to orient the humps 15a and 15b in radial directions which enable the pre-load to be absorbed by compression stresses in the humps 15a and 15b, i.e. in radial directions inclined along the pre-load direction, for example with an angle of 120° between the two humps.

The bottom of each chamber 10 and 11 can be shaped with a respective bulge 18 projecting radially outwards as far as the centre of the chamber, which constitutes an abutment element that can come into contact with the inside surface of the outer armature 1 when the armatures 1 and 2 are displaced relative to one another in the direction B. Beyond a certain displacement threshold one of the bulges 18, depending on the displacement direction, contacts the inside surface 10 so that the rigidity of the joint is increased in the direction B. Thus, the bulges 18 prevent excessive deformation of the deformable element 6 in the direction B in order to avoid damage to the walls 13 and 14 when the joint is subjected to very large radial force.

The armature 7 is embedded in the elastic mass of the deformable element 6. The armature 7 consists of a tube section essentially the same length as the outer armature 1 and coaxial with it, provided in its central portion with two openings 3 each covering a wide angular sector for example of about 120° about the axis A. Each of these openings corresponds to the location of one of the chambers 10 and 11 and allows passage of the bulge 18 so that the latter can abut against the outer armature 1. Thus, at the level of its axial ends the armature 7 forms two rings 20 and 21, which are embedded at the periphery of the walls 13 and 14 respectively and, joining the rings 20 and 21, two steps 22 parallel to the axis A, which are embedded in the humps 15a and 15b respectively. The deformable element 6 also comprises, longitudinally outside the end walls 13 and 14, film portions that cover the ends of the inner armature 2 and of the embedded armature 7.

The strips 22 of the embedded armature 7 are covered on their outer surface by a fine layer of the material of the deformable element 6, which forms the top surface of the humps 15a and 15b respectively and which is applied hermetically against the inside surface of the armature 1 when it is put in position. The volume 9 is sealed by force-fitting the outer armature 1 over the deformable element 6 after filling with the damping liquid. Filling can be effected by immersion of the joint in the liquid. The two rings 20 and 21 impart to the deformable element 6 a high radial rigidity at the level of the walls 13 and 14 to ensure leakproof contact with the outer armature 1. The deformable element 6 is not adhesively bonded to the outer armature 1 but held on it by the friction produced by a thin film of its material crushed radially between the outer armature 1 and the rings 20 and 21.

In this case the hydroelastic joint is of the type with controlled rigidity. For this, a connection circuit is provided which connects the two chambers 10 and 11 and which has two electric valves 26 and 27 for controlling the flow of liquid between the two chambers in the connection circuit. In the embodiment of FIGS. 1 and 2 the connection circuit is essentially arranged in an external casing 25 fixed on the outside of the armature 1. The connection circuit comprises a channel 28 one end of which communicates with the chamber 10 through an opening 29 made in the outer armature 1 and the other end of which opens into a cavity 30 associated with the electric valve 26. An intermediate channel 31 connects the cavity 30 with a cavity 32 associated with the electric valve 27 and a channel 33 connects the cavity 32 to the chamber 11 via an opening 34 made through the outer armature 1.

The electric valve 26 comprises an electric actuator 36, for example of the type with an electromagnet or variable reluctance, which acts on an actuator rod 37 at the free end of which is fixed a vane 38. A spiral spring 39 is arranged around the rod 37 in contact between a back face of the vane 38 and an opposite face of the cavity 30. The electric valve 27 is of the same design. In FIG. 2 the electric valve 27 is shown in the closed state which corresponds to the case when the electric actuator is not energised, and the electric valve 26 is shown in the open state which corresponds to the case when the electric actuator is energised with electricity. The intermediate channel 31 opens into the cavity 30 through a wall 40 of the cavity opposite the vane 38. The actuator rod 37 extends longitudinally perpendicularly to the wall 40 opposite the mouth of intermediate channel 31. The channel 28 opens into the cavity 30 perpendicularly to the channel 31.

When the electric actuator 36 is energized, the electric valve 26 is in the open state corresponding to a two-way pass condition shown in FIG. 2, in which it allows liquid to flow in both directions between the intermediate channel 31 and the liquid chamber 10.

When the electric actuator 36 is not energised, the spring 39 presses the vane 38 against the wall 40. The wall 40 at the periphery of the intermediate channel 31 constitutes a vane seat against which the vane 38 is applied hermetically so that it blocks the mouth of the intermediate channel 31. This condition (only shown for the electric valve 27) corresponds to a one-way pass state of the electric valve. The one-way pass state of the electric valve 26 can be deduced easily from FIG. 2 by imagining the vane 38 pressed against the wall 40, similarly to the electric valve 27. In this state of the electric valve 26 (not illustrated) a flow of liquid or a pressure wave coming from the chamber 10 via the channel 28 cannot reach the intermediate channel 31 because the vane 38 blocks its access. On the contrary, such a flow exerts on the vane 38 a force in the same direction as the force of the spring 39, which contributes towards pressing the vane 38 against the wall 40.

Conversely, and still when the electric actuator 36 is not energised, a flow of liquid or a pressure wave coming from the chamber 11 via the intermediate channel 31 exerts on the vane 38 a force opposed to the force of the spring 39 and can therefore displace the vane 38 so as to move it away from the wall 40 as soon as the pressure in the intermediate channel 31 becomes high enough. The electric valve 26 in the closed state is therefore in a one-way pass state in which it blocks any circulation of liquid from the chamber 10 to the intermediate channel 31 and in which it allows a flow of liquid in the opposite direction from the intermediate channel 31 to the chamber 10, by opposing the pressure exerted by the vane 38 and the spring 39.

There is no need to describe the operation of the electric valve 27, since it is strictly identical to that of the electric valve 26. However, it is important to note that the one-way pass direction of the electric valve 27 in its closed state as shown is from the intermediate channel 31 toward the liquid chamber 11. Thus, the electric valves 26 and 27 have respective one-way pass directions which are opposite.

In FIG. 2 a control device 41 for the electric valves 26 and 27 is represented schematically. For each electric valve this device comprises an electric circuit 42 which connects the two supply terminals of the electric actuator to a source of electric power 43 and a switch 44 for opening or closing the electric circuit 42. Of course, the two electric circuits can be connected to the same power source, for example the vehicle's battery. A control unit 45 controls the switches 44, as indicated by the arrows 46. In FIG. 2 the switch 44 of the electric valve 27 is in the open condition and the switch 44 of the electric valve 26 is closed. Thus, by controlling the electric valves independently the control unit 45 can put the connection circuit connecting the two chambers in four distinct states.

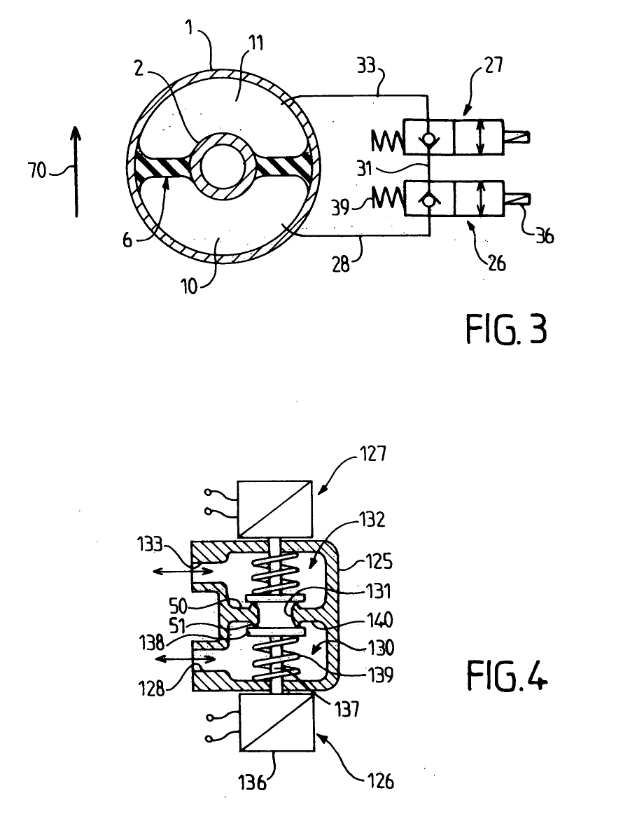

FIG. 3 is a hydraulic layout equivalent to the hydroelastic joint of FIG. 2. The same indexes denote the same elements. In FIG. 3 the two electric valves are in the one-way pass state. Other structures enable equivalent hydraulic operation to be obtained.

FIG. 4 shows a variant design of a connection circuit external to the joint. Elements identical or similar to those of FIG. 2 are given the same index number increased by 100. The casing 125 contains the essentials of the connection circuit and can be fixed on the outer armature 1 analogously to the casing 25 in FIG. 2. In this variant the casing is shorter, with thinner walls, and so enables the formation of a connection between the two chambers 10 and 11 which is both of relatively small length and has a relatively wide passage cross-section, with favourable effect for the filtering of the high frequencies which are commonly encountered in the ground contact members of automobile vehicles and which affect the comfort of the vehicle, for example in a range from about 100 to about 300 Hz.

In the casing 125 the cavities 130 and 132 are separated only by a thin wall 50 in which is made a circular opening 131 connecting the two cavities. The face 140 of the wall 50 that receives the vane 138 of the electric valve 126 has around the opening 131 an annular bead 51 which projects towards the inside of the cavity 130. The bead 51 constitutes a vane seat against which are the vane 138 can rest hermetically. In other respects the design of the connection circuit is similar to the embodiment of FIG. 2. In particular, in the example of FIG. 2 and also in that of FIG. 4 the connection circuit is entirely symmetrical. However, this last characteristic is in no way obligatory. A hydroelastic joint provided with a connection circuit according to the embodiment of FIG. 4 conforms to the same equivalent hydraulic layout as the embodiment of FIG. 2, namely that shown in FIG. 3.

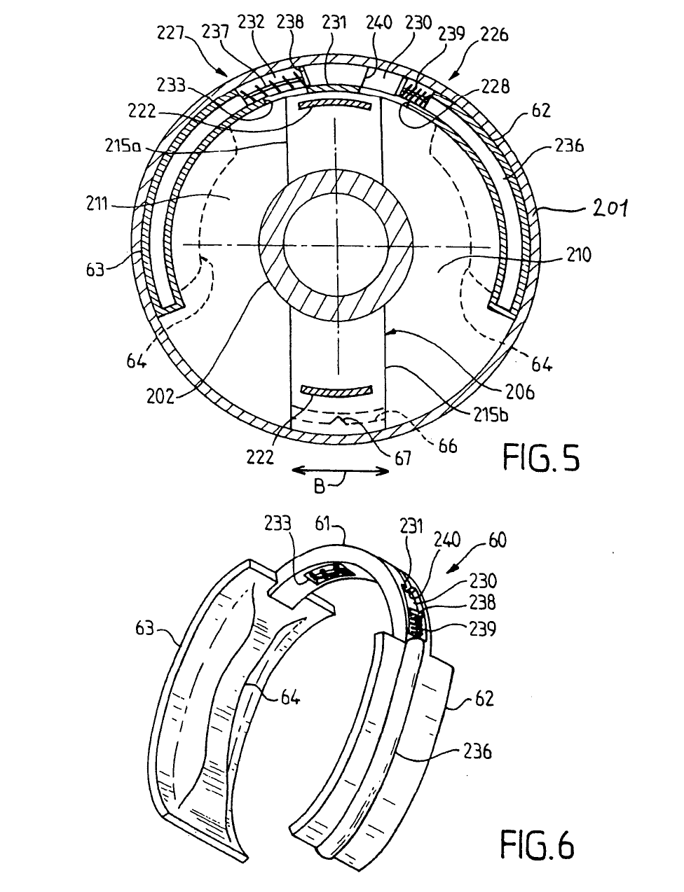

Referring to FIGS. 5 and 6, another embodiment of a hydroelastic joint will now be described, which again conforms to the same equivalent hydraulic layout shown in FIG. 3. In this embodiment the hydraulic circuit connecting the two chambers is completely inside the outer armature of the joint. Elements identical or similar to those in the embodiment of FIGS. 1 and 2 are denoted by the same index numbers increased by 200.

In this embodiment the armature embedded in the elastomeric element 206 is shaped slightly differently from that described in FIGS. 1 and 2. In effect, the longitudinal strips 222 of this embedded armature, which extend into the humps 215a and 215b of the elastomeric element 206, are radially retracted toward the inner armature 202 relative to the end rings of the embedded armature. Thus, some radial space is provided between the strips 222 and the outer armature 201 once the latter is put into position. This radial space, essentially equal to the amount of radial retraction of the strips 222, enables communication channels to extend between the two chambers 210 and 211. On the side of the hump 215b of the elastomeric element 206, the elastomer extends radially as far as the inside radius of the outer armature 201 so as to rest hermetically against the inside surface of the armature 201. On the side of the hump 215a, for example half-way along the joint, a recess is formed in the top of the hump outside the embedded armature. This recess, of rectangular cross-section formed in the peripheral direction of the joint between the two chambers 210 and 211, serves to allow the passage of the central branch 61 of a semi-rigid supporting element 60 which is shown in perspective in FIG. 6.

The supporting element 60, which is made for example of a plastic material, has the overall shape of a split ring whose outside radius corresponds to the inside radius of the armature 201 and whose inside radius corresponds overall to the outside radius of the elastomeric element 206. In the assembled condition, as can be seen in FIG. 5, the supporting element 60 is arranged between the elastomeric element 206 and the outer armature 201, being for example clipped around the elastomeric element 206 before the armature 201 is fitted on. In a manner both compact and modular the supporting element 60 carries the whole of the connection circuit that connects the two liquid chambers 210 and 211 and two electric valves for controlling the circulation of liquid in the said circuit. In the example illustrated, the supporting element 60 has a central branch with rectangular cross-section and two end branches 62 and 63 which are wider in order to improve the stability of the supporting element 60 once it has been positioned. The three branches 61, 62 and 63 are curved with the same radius of curvature. The connection circuit for connecting the two chambers is in this case located essentially in the central branch 61, whose section forms a U along its whole length so as to define an open channel on the radially outer side of the supporting element 60. This channel has an intermediate portion 231 and two end portions 230 and 232, which are wider than the intermediate portion 231 and are each connected to the latter by a shoulder 240. Two rectangular windows 228 and 233 are made through the inner wall of the branch 61 at the level of the end portions 230 and 232 of the channel, respectively, so as to enable those portions to communicate with the chambers 210 and 211, respectively, as shown by FIG. 5. The supporting element 60 carries two electric valves by means of which the intermediate portion 231 of the channel can be blocked independently at the level of its two ends.

Since the connection circuit carried by the supporting element is entirely symmetrical, it will again suffice to describe only the electric valve 226. This comprises a solenoid actuator 236 held in the end branch 62 of the supporting element and an actuation rod 237 that slides relative to the solenoid and has an identical radius of curvature corresponding to that of the supporting element. Such an actuator can be made with a relatively flat and also curved coil. A spiral spring 239 is arranged around the actuation rod 237 in contact with a vane 238 fixed to the free end of the rod 237 to enable the vane 238 to be pressed hermetically against the shoulder 240 when the actuator 236 is inactive. As in the previous embodiments, the actuator 236 enables the vane 238 to be moved to an open position against the action of the spring 239, as shown for the electric valve 226 in FIG. 5. In that figure the electric valve 227 is in the closed position, which is a one-way pass position since it blocks the passage of a flow or pressure wave from the chamber 211 towards the channel 231 but allows a flow or pressure wave to pass from the channel 231 to the chamber 211 by overcoming the pressure loss imposed by the spring. Here again, the electric valves 226 and 227 have one-way pass directions which are respectively opposite. When both electric valves 226 and 227 are open, the damping liquid can circulate freely in both directions between the chambers 210 and 211 through the window 228, the channel portion 230, the channel portion 231, the channel portion 232 and the window 233.

Optionally, the supporting element 60 can have crosspieces 64 projecting radially inwards under the branches 62 and 63 so as to be able to rest against the periphery of the elastomeric element 206 in order to increase the rigidity of the joint. In effect, for an identical displacement of the armatures, the crosspieces 64 can form a coupling between the outer armature 201 and the elastomeric element 206, while providing abutment projections (not shown) less high than the bulges 18 shown in FIG. 1. By reducing the height of the elastomeric abutment projections, their flexibility is also reduced.

The conductors for the supply of electricity to the electric valves 226 and 227 have been omitted in FIGS. 5 and 6. For example, these conductors can run along the inside surface of the armature 201 up to one end of the joint. As in the embodiment of FIG. 2, the joint has a hydraulic damping direction indicated by the arrow B which is defined by the respective positions of the two liquid chambers 210 and 211. With a control circuit similar to that shown in FIG. 2, the joint can in the same way be put into four distinct operating conditions. These operating conditions will now be described with reference to FIGS. 3 and 10.

FIG. 10 shows the displacement d of armature 1 relative to armature 2 as a function of the force F exerted in the damping direction, counted as positive in the direction of the arrow 70 in FIG. 3. The diagram, which only shows positive displacements, is to be understood as symmetrical relative to the origin when the joint has a symmetrical structure. The origin F=0, d=0 represents the rest condition of the joint, which is generally but not necessarily a condition in which the outer and inner armatures are coaxial, as in the embodiments illustrated.

If both electric valves are in the two-way pass state (actuator energised electrically) the connection circuit allows liquid to circulate in both directions between the two chambers and the joint is thus in a condition of low rigidity, represented by the curve 71 in FIG. 10. In this condition the pressure level in the chambers remains low, i.e. it is limited to dynamic effects. As can be seen in FIG. 10, the behaviour of the joint in this condition may be non-linear, for example because of the presence of abutments that come into action after a certain displacement level. The bulges 18 shown in FIG. 1 and the crosspiece 64 shown in FIG. 6 can play such a part.

If the two electric valves are switched to the one-way pass state (the position in the absence of electric energisation shown in FIG. 3), the joint is in a condition of greater rigidity corresponding to the curve 72 in FIG. 10. In effect, the volume of liquid in each chamber is fixed from the moment when the two valves are switched. The switching took place in the rest condition for curve 72. Curve 73 represents the behaviour of the joint in the case when switching took place at a time when a load had already displaced the armatures, in a condition represented by the point 74. In this case the joint's point of dynamic equilibrium is shifted. The slope of the curves 72 and 73 corresponds to the dilation rigidity of the joint, which is determined in particular by the rigidity of the cheeks 13 and 14 of the joint. Thus, it is preferable to design the cheeks 13 and 14 to be rigid if it is desired to obtain a clear difference in the joint's behaviour between the conditions in which the electric valves are open and closed, i.e. a substantial change of slope between curve 71 and curves 72, 73.

In the embodiments described earlier a blocked condition of the connection circuit is obtained by putting the two electric valves in series into one-way pass states whose directions are opposite. Since the flows and pressure waves, whatever their direction, will always push one of the two vanes in its closing direction, this blocking condition is maintained passively without the need to use very stiff springs. The advantage that results from the use of very yielding springs is that the force needed to open the electric valves is small, and can therefore be exerted by actuators of low power and small volume that can be accommodated within the joint if necessary. In the blocking condition of the connection circuit the pressure in the chambers is not zero and is approximately proportional to the variation of the force F starting at the switching point.

If, as shown in FIG. 2, the electric valve 26 is in its two-way pass state while the electric valve 27 is in its one-way pass state, the joint is in an asymmetrical operating mode analogous to a mechanical ratchet. In effect, the joint behaves rigidity in relation to displacements that tend to reduce the volume of the chamber 11, but its behaviour is softer in relation to displacements that tend to increase the volume of the chamber 11, i.e. for example a displacement of the armature 1 in the direction of the arrow 70.

For example, starting from the rest position O of the joint in FIG. 10, a positive force F₀ is applied to the armature 1 and this gives rise to a displacement of liquid from chamber 10 towards chamber 11 and a mutual displacement of the armatures as far as the point 74, as shown by the arrow 75. If the force is relaxed, the joint does not return to the rest condition O because the valve 27 prevents the return of liquid from chamber 11 to chamber 10. As indicated by the arrow 77, the joint then reaches a static, displaced condition 76 in which there is a residual displacement d₀ between the armatures, a corresponding overpressure in chamber 11 and a corresponding lower pressure in chamber 10.

In this asymmetrical operating mode the joint behaves rigidly against forces F in the negative direction, but less rigidly against forces in the positive direction. In particular, as indicated by the arrow 78, the joint reaches a new operating point 79 along the curve 71 if a positive force F₁>F₀ is applied to the armature 1. From point 79, a total relaxation of the force F leads to a new, displaced static condition with a residual displacement d₁>d₀ as indicated by the arrow 80. It is found that the joint behaves in the manner of a one-way ratchet which retains displacements in one direction (here, the positive direction of FIG. 10) in a stable manner, displacements of course produced in response to a force undergone by the joint. To restore the joint's point of static equilibrium to the point 0, the electric valve 27 can be opened at any time.

For the asymmetrical condition opposite to that of FIG. 2 (electric valve 26 closed, electric valve 27 open), the operation exactly mirrors that described above.

The two asymmetrical states of the electric valves can be used to obtain and maintain a displacement (offset) of the armatures in a desired direction. For this it suffices to close the electric valve whose one-way pass direction corresponds to the direction of the offset desired, and to open the other electric valve. When the force on the joint is in the desired direction, a corresponding offset and transfer of liquid will be produced naturally by that force. The offset will then be maintained by trapping the liquid transferred for as long as desired.

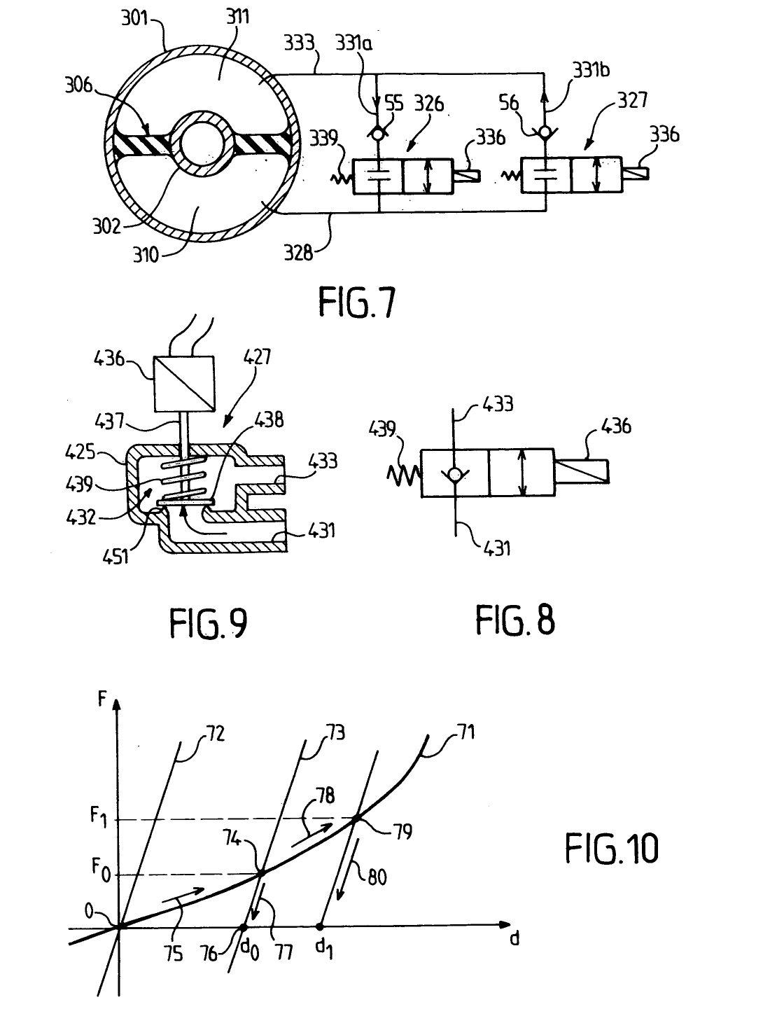

Other connection circuit structures enable operation analogous to that of FIG. 10 to be obtained, as for example the connection circuit of the joint shown in FIG. 7. In that figure elements identical or analogous to those in the embodiment of FIGS. 1 and 2 are indexed with the same numbers increased by 300.

In this case the connection circuit comprises a duct 328 which communicates with the chamber 310 via an opening in the armature 301 and a duct 333 which communicates with the chamber 311 via another opening in the armature 301.

Two duct branches 331a and 331b parallel to one another connect a point in the duct 333 to a point in the duct 328. The branches 331a and 331b comprise respective non-return valves 55 and 56 in series with respective electric valves 326 and 327. The non-return valves are for example spring-loaded ball valves. The two electric valves are identical and have a blocking state, shown in FIG. 7, and a two-way pass state that can be reached under the action of an electric or electromagnetic actuator 336. A spring 339 switches the valve to the blocking state when the actuator 336 is not energised.

The joint has four distinct operating conditions, a rigid condition corresponding to the absence of liquid circulation when the two valves are both in their blocking position, a softer condition corresponding to the pass position of the two valves, and two oppositely asymmetrical conditions corresponding in respective cases to one valve in a pass position and one valve in a blocking position. The operation of the joint in these four conditions is similar to the operation described earlier with reference to FIG. 10.

FIG. 9 shows a variant embodiment of an electric valve that can be used in a connection circuit of the type illustrated in FIG. 3. The electric valve 427 has elements identical or analogous to the elements constituting the electric valve 27 of FIG. 2, which are indexed with the same numbers increased by 400. However, the electric valve 427 is arranged in an individual casing 425 which defines the channel 433 designed to connect the cavity 432 to the chamber 11 and the channel 431 designed to connect the cavity 432 to the other electric valve. The other electric valve can be symmetrically designed. A bead 451 forms a vane seat on the inside wall of the cavity 432 around the mouth of the channel 431. FIG. 8 shows the equivalent hydraulic layout of the electric valve 427. The casing 425 can be fixed on the outer armature of the joint.

According to yet another embodiment of the joint, the electric valve shown in FIG. 9 is used in a connection circuit with two parallel branches. For example, the non-return vane 56 and the electric valve 327 are replaced by the electric valve 427 on the branch 331b in the layout of FIG. 7. An analogous substitution is made in the branch 331a using an electric valve symmetrical to the electric valve 427. In this embodiment the joint can again be switched to four distinct operating conditions. When the two electric valves are in their two-way pass states (actuator energised), the joint is in a soft condition since the liquid can flow in both directions through each branch 331a and 331b between the two chambers. When both electric valves are in their one-way pass states (actuator not energised) the joint is more rigid because the liquid can only flow through one of the two circuit branches 331a and 331b in each direction between the two chambers. When one electric valve is in the two-way pass state (valve energised) and the other in the one-way pass state (valve not energised), the joint is in an asymmetrical condition in which the rigidity corresponding to offsets in one direction is lower than the rigidity corresponding to offsets in the opposite direction. In effect, with a force which tends to transfer liquid in the one-way pass direction of the non-energised electric valve, the liquid can pass from the chamber of origin to the chamber of destination through both of the connection circuit's parallel branches. Conversely, with a force in the opposite direction the liquid cannot pass through the non-energised electric valve in its blocking direction and can therefore only flow through the branch in which the electric valve is energised (open), which makes liquid flow more difficult than in the first direction and so increases the rigidity of the joint in an asymmetrical way. In this embodiment the two asymmetrical states of the electric valves do not allow a static offset between the armatures to be maintained, but will only result in a relaxation time of the liquid which is longer in one direction than in the other, therefore slowing down the return of the joint to its rest condition after an offset corresponding to liquid transfer in the one-way pass direction of the electric valve has been produced.

FIG. 11 is a layout diagram analogous to FIG. 3, which represents another embodiment of a hydroelastic joint. Elements identical or similar to those in the embodiment of FIG. 2 have the same index numbers increased by 500.

Compared with the embodiment of FIGS. 2 and 3, the essential difference is the interchange of the electric valves. The electric valve 526 whose one-way pass direction is oriented from the chamber 511 toward the chamber 510 is positioned nearer chamber 511, while the electric valve 527 whose one-way pass direction is orientated from the chamber 510 towards the chamber 511 is positioned nearer chamber 510. Accordingly, the operation of the joint is the same as that described with reference to FIG. 2, except as regards the pressure condition of the intermediate channel 531 located between the two electric valves. In the embodiment of FIGS. 1 and 2 an electric valve in the non-energised state opens only when the pressure in the channel 31 exceeds the pressure present in the chamber of the joint located on the other side of the electric valve. Thus, the electric valves always tend to allow communication between the intermediate channel 31 and whichever of the two chambers 10 and 11 has the lower pressure. The channel 31 is therefore always in a relatively low pressure condition regardless of the mode of operation of the joint, in particular in the most rigid mode and in the asymmetrical modes. In the embodiment of FIG. 11, an electric valve in the non-energized state only opens when the pressure in the channel 531 is lower than the pressure present in the chamber of the joint located on the other side of the electric valve. Thus, the electric valves always tend to allow communication between the intermediate channel 531 and whichever of the two chambers 510 and 511 has the higher pressure. Accordingly, the channel 531 is always in a state of relatively high pressure regardless of the joint's mode of operation, in particular in the most rigid mode and in the asymmetrical modes.

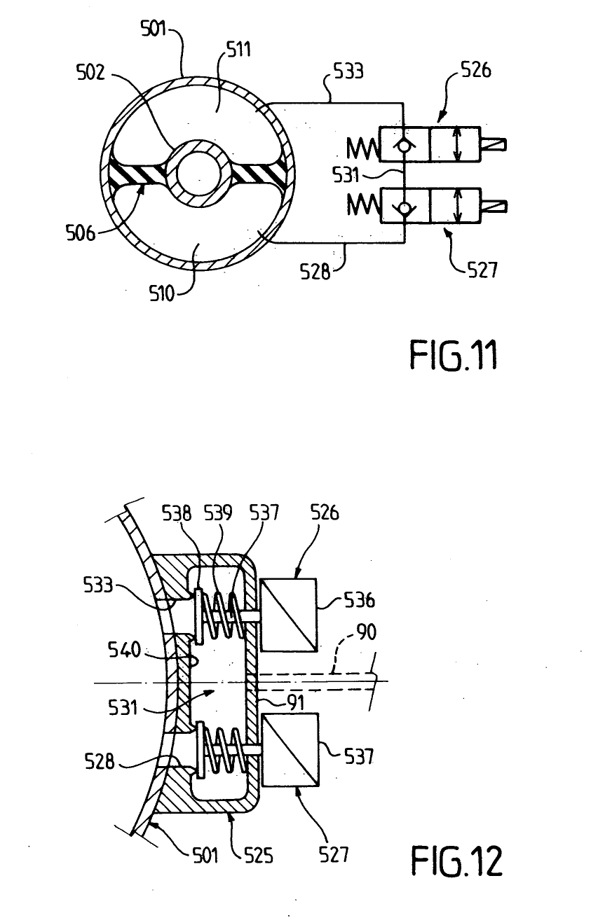

FIG. 12 shows an embodiment of the hydraulic circuit of FIG. 11. This circuit is formed in a casing 525 designed to be fixed on the outer armature of the joint like the casing 25 in FIG. 2, by any appropriate fixing means (adhesive, welding, or other).

The casing 525 comprises an elongated cavity 531 extending in a direction tangential to the surface of the outer armature. The wall 540 facing toward the joint has two cylindrical passages 528 and 533 designed to communicate with the chambers 510 and 511 via corresponding apertures in the armature 501. The wall 91 of the casing facing away from the wall 540 has the electric actuators 536 and 537 of the two electric valves. The electric valve 526 has an actuation rod 537 which extends across the cavity 531 in the axis of the passage 533, and whose free end carries a vane 538 which is applied hermetically against the wall 540 around the mouth of the passage 533 so as to block that passage, under the action of a spring 539. A circular bead projecting towards the inside of the cavity 531 can be provided on the wall 540 as a vane seat. The electric valve 527 is of identical design and is positioned at the other end of the cavity 531, opposite the passage 528.

Optionally, a duct 90 can be provided which opens into the cavity 531, for example through the wall 91, so as to connect the volume of liquid between the two electric valves to another hydraulic component, for example a pressure sensor, a supply of pressurised liquid, a discharge vane or suchlike.

The joints described above are designed to be in their most rigid condition when the electric valves are not energised. Similarly, a joint could be designed which is soft in its default state, by interchanging the role of the restoring element and the actuator in the electric valves.

Besides the connection controlled by valves, the joint can comprise one or more overpressure channels designed to connect the chambers in the event of a very large force on the joint, to avoid bursting of the joint. Such channels with a safety function are known in themselves. For example, FIG. 5 includes an overpressure channel 66 formed through the hump 215b radially outside the embedded armature, and provided with a vane lip 67 greatly compressed against the opposite wall of the channel 66 so as to block the overpressure channel 66 but to open if the pressure difference between the chambers reaches a high value.

The hydraulic circuit connecting the two chambers can be inside or outside the outer armature of the joint. In the latter case it can be supported by the outer armature or, at least in part, it can run a distance away from the outer armature of the joint and be supported as necessary by other supports.

Although the invention has been described in relation to a number of particular embodiments, it is quite clearly in no way limited to these and includes all technical equivalents of the means described and their combinations where these fall within the scope of the invention.

The hydraulic circuits represented or described in the above embodiments can be used in applications other than hydroelastic joints, for example in industrial machinery, public works engines or pressure accumulators. A duct for liquid or for gas which comprises two electric valves of the type described arranged so as to have mutually opposed one-way pass directions has various advantages, in that it enables two cavities holding liquid or gas to be connected in four distinct connection modes, depending on the respective states of the electric valves, while taking up little space and consuming little electricity.

1. A hydroelastic joint for connecting two components while damping vibrations transmitted between one and the other, said joint comprising:
an outer armature (1, 201, 301, 501) and an inner armature (2, 202, 302, 502) arranged one around the other;
an elastically deformable element (6, 206, 306, 506) arranged between said armatures so as to allow relative movement between said armatures, said elastically deformable element being shaped so as to define, between said armatures, a volume containing a damping liquid and comprising at least two chambers (10, 11; 210, 211; 310, 311; 501, 511) opposite one another along a predefined damping direction (B);
a connection circuit connecting said chambers; and
flow control means that can be switched between several conditions in order to modify a flow resistance of said connection circuit between the two chambers,
wherein said flow control means (26, 27; 126, 127; 226, 227; 326, 327; 427; 526, 527) have a first asymmetrical condition in which the flow resistance of the connection circuit is lower in a first direction from a first of said chambers to a second of said chambers than it is in a second direction from said second chamber to said first chamber, and a second asymmetrical condition in which the flow resistance of the connection circuit is lower in said second direction than in said first direction.

2. The hydroelastic joint according to claim 1, wherein the first asymmetrical condition and the second asymmetrical condition are two one-way pass states in which the flow control means block a flow of damping liquid in the second direction and in the first direction, respectively.

3. The hydroelastic joint according to claim 1, wherein said flow control means comprise two controlled valves (26, 27; 126, 127; 226, 227; 326, 327) arranged in the connection circuit between said first chamber and said second chamber, each of said valves having a two-way pass state and a one-way pass state, a first (27) of said valves having a one-way pass state oriented in said first direction (70) and a second (26) of said valves having a one-way pass state oriented in said second direction.

4. The hydroelastic joint according to claim 3, wherein said two valves (26, 27; 126, 127; 226, 227; 526, 527) are arranged in series between the first chamber and the second chamber.

5. The hydroelastic joint according to claim 4, wherein said first valve (27) is arranged on the side near the second chamber and the second valve (26) is arranged on the side near the first chamber.

6. The hydroelastic joint according to claim 3, wherein said connection circuit comprises flow guiding means (28-33; 128-133; 228-233) for guiding a flow of the damping liquid between said chambers, each of the two controlled valves comprising a vane (38, 138, 238) arranged inside said flow guiding means and able to move between a blocking position corresponding to the one-way pass state of the valve, in which said vane separates two portions (30, 31; 130, 131; 230, 231) of the flow guiding means and at least one open position corresponding to the two-way pass state of the valve, in which the vane re-establishes flow continuity between the two portions of the flow guiding means, a restoring element (39) moving said vane toward said blocking position and an actuator (36, 136, 236) being able to move the vane to said at least one open position, the vane in said blocking position being arranged so that the pressure of the damping liquid in one of said portions of the flow guiding means moves said vane to the open position against the action of said restoring element, while the pressure of the damping liquid in the other of said portions of the flow guiding means moves said vane toward its blocking position.

7. The hydroelastic joint according to claim 6, wherein the vane is guided in a direction corresponding essentially to the flow direction of the damping liquid in said flow guiding means.

8. The hydroelastic joint according to claim 6, wherein said flow guiding means comprise a casing (25, 125, 425) arranged outside the outer armature (1, 301) of the joint, said casing having walls that delimit an inside volume (30, 32; 130, 132; 432), said walls being pierced by two openings arranged so as to allow communication between said inside volume and each of the two chambers, said vane being mobile within said inside volume, said vane being able to rest hermetically against the inside face (40, 140) of a wall of the casing around one of said openings.

9. The hydroelastic joint according to claim 8, wherein said restoring element (39, 139, 439) is a spiral spring in contact with the vane and with a wall of the casing.

10. The hydroelastic joint according to claim 8; wherein the vanes of the two valves are arranged in two inside volumes (130, 132) of a common casing (125) with an internal partition wall (50) which separates the two inside volumes, said internal partition being pierced by a connection opening (131) that connects the two inside volumes, the vane seats (51) of the two vanes being formed on the two faces of said internal partition around the said connection opening.

11. The hydroelastic joint according to claim 3, wherein the two chambers (210, 211) are defined by recesses formed on the surface of the elastically deformable element (206) facing toward the outer armature, the joint comprising an intermediate supporting element (60) arranged between the outer armature (201) and the elastically deformable element, said supporting element comprising a first end portion (62) located opposite the first chamber (10), a second end portion (63) located opposite the second chamber (211) and an intermediate portion (61) that connects said first and second end portions and is inserted hermetically between the outer armature and the elastically deformable element, said connection circuit comprising a connection channel (230, 231, 232) formed in said supporting element, said connection channel having two ends (228, 233) that communicate with the first and second chambers respectively, said first and second valves each having an actuator (236) fixed respectively to one of said end portions and a mobile vane (238) that can block said connection channel in the one-way pass state of the valve.

12. The hydroelastic joint according to claim 111, wherein the overall shape of the joint has a circular cross-section and the supporting element (60) is of correspondingly curved shape.

13. The hydroelastic joint according to claim 1, wherein said connection circuit (228-233) and said flow control means (226, 227) are arranged essentially between the outer armature and the elastically deformable element.

14. The hydroelastic joint according to claim 1, wherein the connection circuit comprises a first circuit branch (331b) having two ends in communication with the two chambers (310, 311) respectively and a second circuit branch (331a) having two ends in communication with the two chambers respectively, said second circuit branch following the contour of said first circuit branch, the flow control means comprising a valve (326, 327; 427) arranged on each of the two branches.

15. The hydroelastic joint according to claim 14, wherein said first circuit branch comprises a first one-way blocking element (56) whose pass direction is the first direction and whose blocking direction is the second direction, and a first controlled valve (327) arranged in series with said first one-way blocking element, said second circuit branch comprising a second one-way blocking element (55) whose pass direction is the second direction and whose blocking direction is the first direction, and a second controlled valve (326) arranged in series with said second one-way blocking element, said first and second controlled valves each having a pass state which allows flow in the corresponding circuit branch and a blocking state which blocks flow in the corresponding circuit branch.

16. The hydroelastic joint according to claim 1, wherein said flow control means comprise at least one electric valve (26, 27, 126, 127, 226, 227, 326, 327, 427).

17. The hydroelastic joint according to claim 1, wherein said flow control means have a blocking state which prevents any flow in the connection circuit in both directions between the two chambers.

18. The hydroelastic joint according to claim 1, wherein said flow control means have a symmetrical pass state in which the flow resistance in the connection circuit between the two chambers is essentially the same in both directions.

19. The hydroelastic joint according to claim 1, further comprising at least one overpressure channel (66) whose effective cross-section is larger than that of said connection circuit, which connects said two chambers following the contour of said connection circuit, said overpressure channel comprising an overpressure vane (67) which normally blocks said overpressure channel but can open said pressure channel when the pressure difference between said chambers exceeds a predetermined threshold.
